(19) United States
(12) Patent Application Publication
(10) Pub. No.: US 2014/0154499 A1
(43) Pub. Date: Jun. 5, 2014

(54) Method and Membrane for Nanoporous, Bicontinuous Cubic Lyotropic Liquid Crystal Polymer Membranes that Enable Facile Film Processing and Pore Size Control

(71) Applicants: Douglas L. Gin, Longmont, CO (US); Blaine M. Carter, Boulder, CO (US); Brian R. Wiesenauer, Boulder, CO (US); Evan S. Hatakeyama, Hillsboro, OR (US); Richard D. Noble, Boulder, CO (US); John L. Barton, Athens, PA (US)

(72) Inventors: Douglas L. Gin, Longmont, CO (US); Blaine M. Carter, Boulder, CO (US); Brian R. Wiesenauer, Boulder, CO (US); Evan S. Hatakeyama, Hillsboro, OR (US); Richard D. Noble, Boulder, CO (US); John L. Barton, Athens, PA (US)

(73) Assignee: The Regents of the University of Colorado, a body corporate, Denver, CO (US)

(21) Appl. No.: 14/234,362

(22) PCT Filed: Jul. 22, 2012
(86) PCT No.: PCT/US2012/047779

§ 371 Date: Jan. 22, 2014

Related U.S. Application Data
(60) Provisional application No. 61/510,931, filed on Jul. 22, 2011.

(51) Int. Cl. C08J 5/00; C08F 26/06

(52) U.S. Cl. CPC C08J 5/00; C08F 26/06
USPC 428/316.6; 427/517; 521/150

(57) ABSTRACT

A method of forming a nanoporous membrane includes preparing a solution of a gemini Imidazolium Lyotropic Liquid Crystal (LLC) monomer, a polar low-volatility organic solvent, and a radical photo-initiator in a volatile organic solvent; solvent-casting the solution onto a porous material, evaporating the volatile organic solvent; heating such that the gemini imidazolium monomer forms a Q-phase material and photopolymerizing the imidazolium monomer by exposing the radical photo-initiator to UV light; and exchanging the polar low-volatility organic solvent. Also disclosed is a membrane composed of polymerized gemini imidazolium LLC monomers, and a thin-film composite membrane having the Q-phase material supported on a porous supporting membrane.

### RELATED APPLICATIONS

The present application claims priority to U.S. Provisional Application 61/510,931 filed 22 Jul. 2011, the contents of which are incorporated herein by reference. The present document also relates to, but does not claim priority from, U.S. patent application Ser. No. 11/773,044, filed Jul. 3, 2006 entitled “Surfactants and Polymerizable Surfactants Based on Room-temperature Ionic Liquids (RTILs) that Form Bicontinuous Cubic Lyotropic Liquid Crystal Phases with Water and Other RTILs,” and PCT Patent Application PCT/US10/43124, filed Jul. 23, 2010 entitled “Imidazolium-based Room-temperature Ionic Liquids, Polymers, Monomers, and Membranes Containing the Same”. The document is also related to the material of U.S. patent application Ser. No. 12/121,617 filed May 15, 2008, in that it references a synthesis described in that application.

### GOVERNMENT RIGHTS

This invention was made with government support under grant number CBET-0853554 awarded by the National Science Foundation and grant number W911NF09-C-0108 awarded by the U.S. Army Research Office. The government has certain rights in the invention.

### FIELD OF THE INVENTION

This invention relates generally to the field of nanoporous polymers based on the crosslinking of lyotropic liquid crystal (LLC) (i.e., ordered surfactant) phases, which can be used for selective, molecular-size-based membrane separations. More specifically, this invention relates to the development of two new methods for formulating and preparing LLC polymer membranes based on bicontinuous cubic (Q) LLC phases with 3D-interconnected fluid-filled nanopores. These new Q-phase formulation approaches allow for facile thin film processing with retention of the desired nanostructure, and the ability to vary the effective nanopore size to control molecular-size filtration selectivity.

### BACKGROUND

LLCs are amphiphilic molecules (i.e., surfactants) that self-organize in water (or another polar liquid) into ordered yet mobile phase-separated assemblies containing periodic, fluid-filled, nanometer-scale domains. Each LLC amphiphilic molecule has at least one polar, water-miscible head group, and at least one oil-miscible, non-polar, tail group. Some of the molecules discussed here are single-head, single-tail molecules with one polar head group and one non-polar tail, others are gemini molecules having two linked polar head groups and two non-polar tails.

Lyotropic liquid crystal (LLC) phase materials enable formation of materials with ordered, water-filled, ionic pores with different degrees of dimensional interconnectivity (1D, 2D, and 3D) and uniform pore sizes in the 0.6-1.5 nm range. By using reactive LLCs, these ordered nanoporous structures are covalently stabilized to generate robust, yet flexible nanoporous materials for applications such as membrane separations. In particular, we have found that membranes formed from polymerizable, type I bicontinuous cubic (QI), LLC phases (FIG. 1A) are especially valuable for membrane transport applications. This is because, when stabilized into a polymeric material, the open-framework of 3D-interconnected pores in bicontinuous cubic (Q) phases provide pores having good accessibility for catalysis and transport compared to lower-dimensionality LLC phases such as the 1D cylindrical hexagonal (H) and 2D lamellar (L) phases.

For these reasons, in Q-phase materials, there is no need for bulk sample or pore alignment for the membrane to have good transport properties because their cubic symmetry and 3D pore interconnectivity allows molecules entering a pore on one side of a sample to translate to the other side with little pore blocking. The QI phases (which have 3D-interconnected annulus slit-type pores instead of 3D-interconnected circular pores found in typical type II Q phases (1b)) have also been found to have the unique ability to form uniform, sub-nanometer size pores.

Sub-nanometer pores are valuable for separating small molecules based on molecular size differences. We previously showed that several gemini (i.e., twinned or double head and tail) LLC monomer platforms, including a phosphonium monomer having a pair of side groups each with formula CH2-(CH)3-(CH2)10-PH2+ and a linking group coupled between the phosphonium groups (monomer 1) and an ammonium monomer having a pair of side groups with formula CH2-(CH)3-(CH2)X-NH2+ and a linking group coupled between the ammonium groups, (monomer 2) can form QI phases with water, and can be cross-linked with retention of the LLC phase structure in supported films to afford nanoporous polymer membranes that perform molecular sieving in water. That is, these LLC polymer membrane materials can reject larger hydrated salt ions and dissolved organic molecules while passing smaller water molecules (0.25 nanometer kinetic diameter) in such applications as desalination and nanofiltration (NF), with an effective membrane pore size of 0.75 nm or 0.86 nm. These and related QI-phase LLC polymer membranes can also be applied in vapor separations to separate mixtures of gaseous molecules that straddle these nanopore sizes.

These initial QI-phase LLC polymer membranes have a number of advantages over traditional, non-LLC-based water desalination and NF membranes (i.e., dense reverse osmosis membranes and traditional porous NF membranes), such as uniform pore sizes on the molecular size scale and the potential for nanopore size and environment tuning. However, even with a significant reduction in the cost and synthesis difficulty of the LLC starting materials via the design of gemini ammonium monomer platform it was found these membrane materials have challenges when it comes to potential industrial development and commercialization.

The first and most hampering liability is the difficulty in processing thin films of QI-phase LLC monomer mixtures onto membrane supports followed by polymerization to form thin-film composite membranes with high water fluxes. In membrane science, thicker membrane active layers offer more resistance to flow through the material, so viable membranes usually require very thin (0.1-10 μm) active layers in order to achieve reasonable throughput. One major obstacle to fabricating thin (1-10 μm thick) films of cross-linked QI phases on membrane supports is that LLC monomer phases in general are sensitive to changes in system composition as well as temperature. This is especially true for Q phases, which have sensitive saddlepoints in phase formation with respect to interfacial energy and phase curvature. Consequently, solvent-casting of Q phases using our earlier ammonium and phosphonium monomers and water is not a viable thin-film processing method because any small amount of residual casting solvent remaining after evaporation may lead to LLC phase disruption and shifting of the phase diagram. Alternatively, evaporation of the casting solvent can also lead to loss of some of the water needed for LLC phase formation, resulting in phase changes or disruption before cross-linking locks in the nanostructure. Although thin film processing of a Q monomer phase without casting solvents is an option, evaporative loss of water can still occur during drawdown into high-surface-area thin films, leading to LLC phase disruption. Consequently, the composition sensitivity of Q phases and the water required for LLC phase formation are liabilities during thin film processing in general. These issues are not usually encountered in thin film processing of conventional polymer-based membrane systems. It should also be noted that thin film processing trials on QI-phase monomer 2b/water mixtures under constant humidity conditions (i.e., to minimize water loss/uptake) unfortunately did not show much promise.

### Melt-Press-Photopolymerize or Hot-Press Process

A method, for preparing supported membranes of the cross-linked QI phases of the phosphonium and ammonium monomers illustrated in 2 involved:
a) Spreading the monomers with a radical photoinitiator mixture on 35-40 micron thick microporous fiber matte support (Solupor E075-9H01A), of 3-5 cm diameter and positioning these fiber matte supports between Mylar sheets,
b) heating (55-70° C.) the monomer mixture
c) pressing (8-12 tons force) the initial QI-phase monomer-coated supports,
d) clamping pressed and coated supports between quartz plates
e) photo-polymerizing the LLC monomer gel at 55-70° C. with 365 nm light to lock-in the QI phase, as confirmed by powder X-ray diffraction (XRD) and FT-IR analysis.

The resulting optically transparent and flexible membranes are typically 35-40-μm thick and about 3-5 cm in diameter. Although workable for making small-area, thick supported membranes for laboratory scale NF studies, this “melt-press-photopolymerize” processing method is unsuitable for making high-flux, thin supported membranes on a large scale. Consequently, alternative and more viable processing methods for making thinner films of these new membrane materials are needed for commercialization of these membrane materials.

The second challenge with these QI-phase LLC polymer membranes is the need for methods to control effective nanopore size in these materials, as a means of tailoring separation selectivity. Unfortunately, recent work in our group has shown that variation of the amount of water in the LLC phase and systematic variation of the LLC structure (e.g., changes to monomer tail and headgroup spacer length) for a particular gemini LLC monomer, does not reliably change the QI-phase unit cell dimensions or the effective nanopore size when processed according to the hot-press process.

### SUMMARY

An imidazole group is known in the art as having an 5-atom ring having two nitrogen atoms and three carbon atoms that may ionize in water; an imidazolium salt is an ionic compound having a positively ionized imidazole group and a negative ion, such as a bromide ion. The imidazolium monomers discussed herein have one or two such positive-charged groups.

A new method of forming a nanoporous membrane includes preparing a solution of a gemini imidazolium LLC monomer, a polar low-volatility organic solvent, and a radical photo-initiator in a volatile organic solvent; solvent-casting the solution onto a porous material, evaporating the volatile organic solvent; heating such that the gemini imidazolium monomer forms a Q-phase material; photo-polymerizing the imidazolium monomer by exposing the radical photo-initiator to light; and exchanging the polar low-volatility organic solvent with water.

The nanoporous membrane=has a polymer of at least one gemini imidazolium lyotropic liquid crystal monomer selected from the group consisting of 1,4-Bis(tetradeca-11,13-dienylimidazolium)butane dibromide (monomer 3a), 1,6-Bis(tetradeca-11,13-dienylimidazolium)hexane dibromide (monomer 3b), 1,1′-(oxydi-2,1-ethanediyl)bis[3-(tetraadeca-11,13-dienyl)imidazolium] dibromide (monomer 3c), 1,4-Bis(octadeca-15,17-dienylimidazolium)butane dibromide (monomer 3d), 1,6-bis(octadeca-15,17-dienylimidazolium)hexane dibromide (monomer 3e), and 1,1′-(Oxydi-2,1-ethanediyl)bis[3-(octadeca-15,17-dienyl)imidazolium] dibromide (monomer 3f).

### BRIEF DESCRIPTION OF THE FIGURES

1A is a schematic illustration of a polymerizable, type I bicontinuous cubic (QI), LLC phase material having 3D interconnected annulus slit-type pores. 1B is a schematic illustration of a polymerizable, type II, bicontinuous cubic (QII) LLC phase having 3D-interconnected circular pores.

FIG. 2 is a schematic illustration of structures of 1^{st}- and 2^{nd}-generation Q_{I}-phase gemini LLC monomers based on phosphonium and ammonium headgroups; and a mechanism of molecular sieving in water for nanofiltration desalination.

FIG. 3 is a schematic illustration of structure of imidazolium-based gemini LLC monomers, referenced herein as the monomer 3 family, including monomer 3E, defined with reference to Table 1.

FIG. 4 is a partial phase diagram showing conditions where a QI phase forms at 65° C. in water-glycerol suspensions of imidazolium LLC Monomer 3E.

FIG. 5 is a flowchart of a new method of forming crosslinked, QI-phase, Gemini LLC membranes using a volatile organic solvent, a polar organic solvent, and an imidazolium-based LLC monomer.

FIG. 6 is an XRD plot and PLM photograph verifying crosslinked QI-phase Gemini LLC formation using the new method.

FIG. 7 is an illustration of

FIG. 8 is a schematic illustration of structure of a single-head/single-tailed imidazolium derivative referenced herein as monomer 4.

FIG. 9 illustrates some interesting properties of the monomers studied.

### DETAILED DESCRIPTION OF THE EMBODIMENTS

### New Processes

We have discovered two new approaches for formulating and preparing QI LLC monomer phases that address the two challenges/liabilities described above. These two new LLC phase formulation methods are: (1) the use of high boiling/less volatile organic solvents such as glycerol or water/organic mixtures to form QI phases with gemini LLC monomers instead of pure water; and (2) the use of mixtures of a gemini LLC monomer and a single-tailed LLC monomer to form QI phases in water, glycerol, or their mixtures.

The first new formulation method overcomes the phase disruption problems associated with unwanted evaporative water loss in these composition-sensitive QI monomer phases when forming thin films prior to polymerization. Consequently, this discovery now allows conventional thin film processing techniques such as solution-casting to be successfully employed on QI-phase monomer systems to make thinner films. The first and the second new formulation methods both appear to be able to vary the effective nanopore size of the QI phases formed by gemini LLC monomers, thereby opening new avenues for pore size control in the resulting polymer membranes.

### Use of Glycerol and Water/Glycerol Mixtures to Form Polymerizable QI-phase Monomer Assemblies that Enable More Facile Thin Film Processing and Pore Size Variation

LLC phases are typically formed by amphiphilic molecules in water as the main hydrophilic solvent. However, a handful of examples of non-aqueous (i.e., non-water-based, or water-free) LLC systems are known in the literature, in which the water traditionally required for LLC self-assembly is replaced by a polar organic solvent. The polar organic solvents that have been used successfully as water substitutes for LLC assembly have included ethylene glycol, glycerol, formamide, N-methylformamide, dimethylformamide, N-methylsydnone, and propylene carbonate. These polar, organic solvents have been found to form a number of LLC phases (L, Q, H), typically with ionic and non-ionic surfactants and natural lipids in water-free compositions. Only one prior example of a polymerizable surfactant or LLC monomer forming LLC phases with a conventional organic solvent (propylene carbonate) is known to us.

In addition to conventional organic solvents, room-temperature ionic liquids (RTILs) have also been used as water substitutes for LLC phase formation. RTILs are polar, liquid organic salts under ambient conditions that are typically based on substituted imidazolium, phosphonium, ammonium, and related organic cations, complemented by a relatively non-basic and non-nucleophilic large anion.

We hypothesized that if we could use a high boiling and relatively low volatility organic solvent to form a QI-phase with a LLC monomer instead of water, we could obtain cross-linkable QI-phases that could be processed into thin films with less susceptibility to evaporative solvent loss and system composition drift. This feature would then allow retention or ready re-formation of the desired QI-phase after conventional thin film processing procedures to make thin composite membranes.

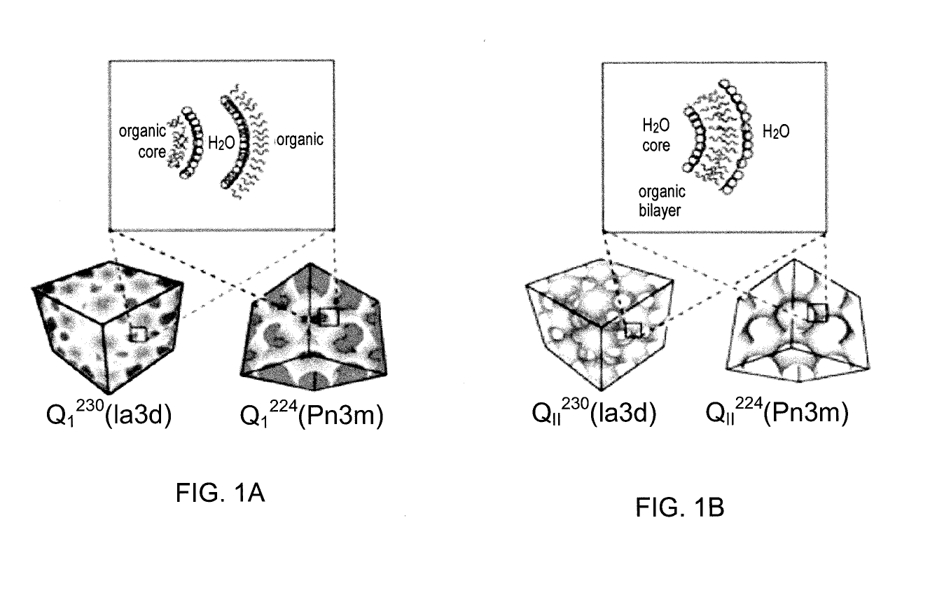

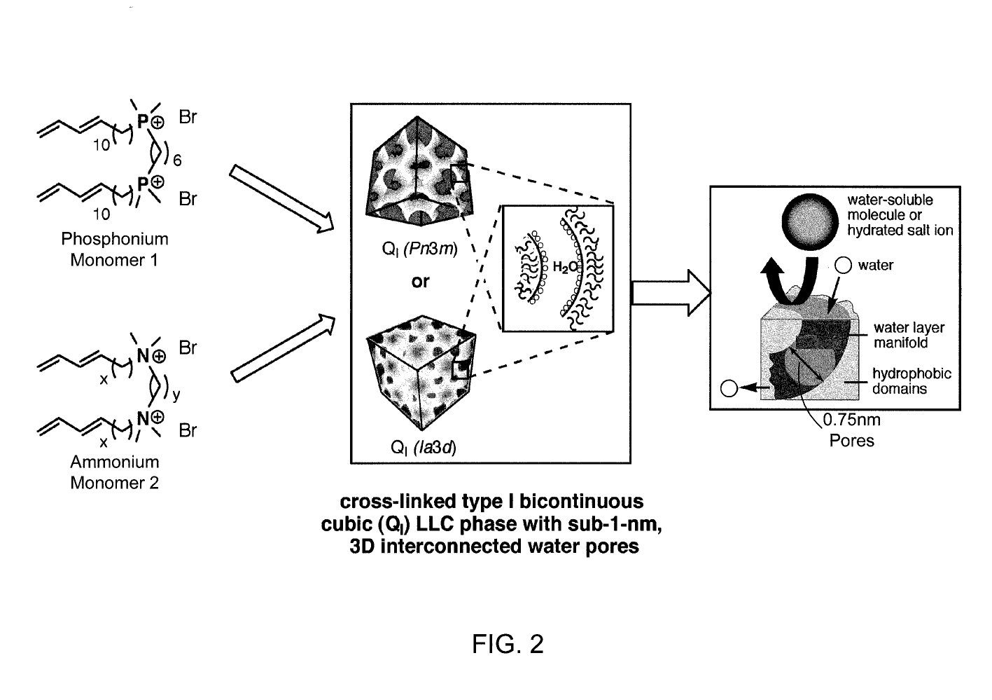

We found that the gemini ammonium LLC monomers illustrated in FIG. 2 did not readily form LLC phases with several polar organic solvents (formamide, glycerol, ethylene glycol) and a model RTIL (ethylammonium nitrate). This is because of the apparent poor interfacial compatibility of the gemini ammonium LLC platform with polar organic solvents, most likely due to the small, “hard” cationic ammonium cations serving as headgroups. We were unable to do phase formation studies with the same non-aqueous solvents with gemini phosphonium LLC monomer of FIG. 2 because this monomer is expensive and difficult to synthesize in sufficient quantities for extensive testing even on the laboratory scale.

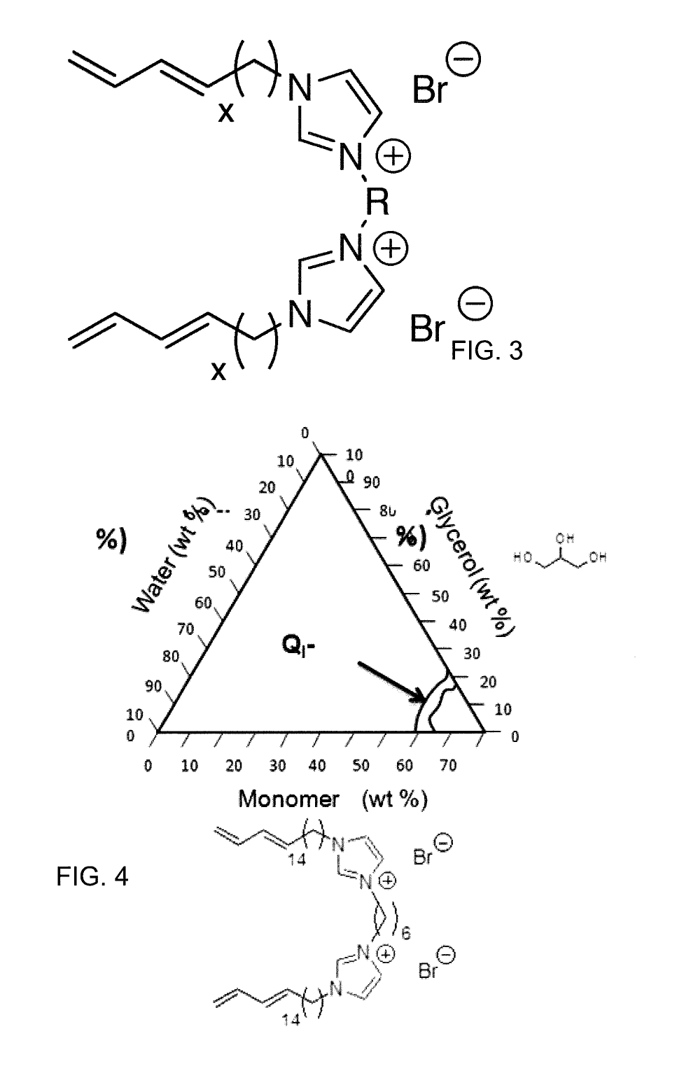

We were able to show that LLC phases with several non-aqueous solvents could be formed with a group of new gemini imidazolium LLC monomer platforms, including the desired QI phase for membrane applications. The compositions of gemini imidazolium monomer, illustrated in FIG. 3, and its homologues/variants are the subject of U.S. patent application Ser. No. 11/773,044, filed Jul. 3, 2006 and PCT Patent Application PCT/US10/43124, filed Jul. 23, 2010. Monomers tested include, where R is the crosslinking chain and X a multiple of CH₂ groups illustrated in FIG. 3:

TABLE 1
Imidazolium Monomers Tested

| Monomer | R | X |
|---|---|---|
| 3a | (CH₂)₄ | 10 |
| 3b | (CH₂)₆ | 10 |
| 3c | (CH₂)₂O(CH₂)₂ | 10 |
| 3d | (CH₂)₄ | 14 |
| 3e | (CH₂)₆ | 14 |
| 3f | (CH₂)₂O(CH₂)₂ | 13 |

Demonstration of LLC phases was accomplished by using the penetration scan technique, a solvent-LLC gradient assay using polarized light microscopy (PLM) that quickly (i.e., in minutes) determines qualitatively if LLC phases could be formed by a LLC monomer at a certain temperature. The identity of each LLC phase formed was then determined by powder X-ray diffraction (XRD) on samples prepared in bulk in a full phase diagram study. The larger, more charge-delocalized cationic imidazolium headgroups apparently make it more compatible with polar organic solvents.

In particular, of all of the homologues and derivatives of the imidazolium monomers prepared and tested, it was found that monomer 3e (R=(CH₂)₆, x=14) had the greatest propensity to form QI phases. Monomer 3e readily forms QI phases with pure formamide, glycerol, or ethylammonium nitrate as the lyotropic solvent instead of water. In addition, it was found that monomer 3e readily forms QI phases with glycerol/water mixtures of varying proportions as well. As mentioned above, the use of non-aqueous solvents to form LLC phases has mostly been investigated with non-polymerizable surfactants and LLCs. To our knowledge, only two examples of non-aqueous LLC phase formation with polymerizable LLC monomers are known in the literature. One involved formation of H phases with an imidazolium RTIL as the solvent; the other involved formation of QII phases with propylene carbonate as the solvent.

Glycerol and glycerol/water-based QI phases of monomer 3e were examined in more detail for processing and water NF performance because they were the easiest to work with, and glycerol has a very high boiling point (290° C.) and very low vapor pressure at room temperature (<1 torr at 20° C.). These features made the glycerol-based QI monomer phases of 3e ideal for thin processing trials with minimum evaporative solvent loss. In addition, these QI-phases could be readily radically photo-cross-linked with retention of the phase architecture. Furthermore, the water-miscible glycerol can be easily and almost quantitatively exchanged with water by soaking and then filtering polymerized films of the material with de-ionized water (<22 ppm residual glycerol after exchange). FIG. 4 shows a partial 3-component phase diagram for monomer 3e, water, and glycerol at 65° C., showing the position of the desired QI phase regime. Other non-cubic LLC phases were also observed outside of the QI phase region, but these have not been rigorously identified yet.

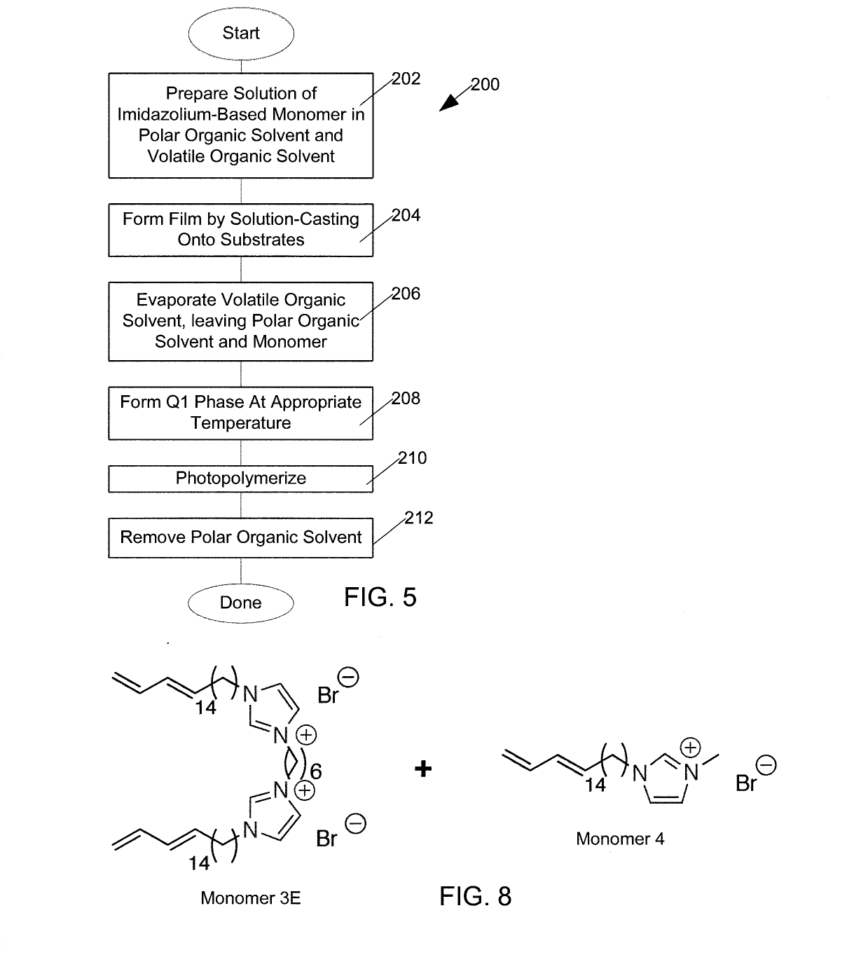

Experiments have shown that a method 200 for thin film processing of a glycerol-based QI monomer phase of gemini imidazolium LLC monomer 3e is possible via solvent-casting from a volatile casting solvent (in an embodiment methanol (CH₃OH)), which readily dissolves the monomer, polar organic QI-forming low-volatility solvent (in an embodiment glycerol ((CH₂OH)₂CHOH)) and an added radical photo-initiator to form a solution 202. The solution is solvent-cast 204 onto a supporting porous material, such as a porous membrane, to form a thin film The volatile casting solvent (which in an embodiment is methanol, and in alternative embodiments is ethanol or isopropanol) is then be removed 206 from the cast film via gentle heating, without significant evaporative loss of the less volatile polar organic solvent in the LLC phase. This allows retention of the desired system composition and re-forming of the QI morphology when the cast film is reheated 208 into the QI-phase temperature regime and exposed to light of a wavelength suitable for the radical photo-initiator and the monomers to photo-polymerize 210. The polar organic QI-forming solvent is then exchanged 212 to prepare the film for use. This method is shown schematically in FIG. 5, with evidence of QI phase retention in the final film provided by XRD analysis.

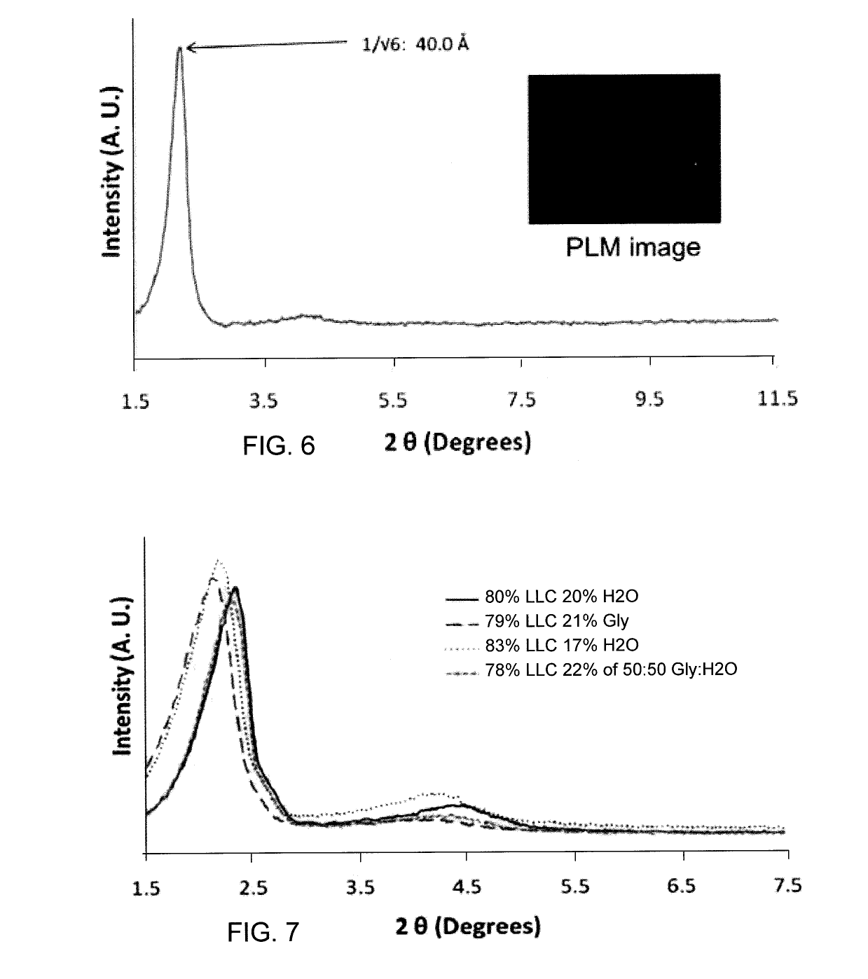

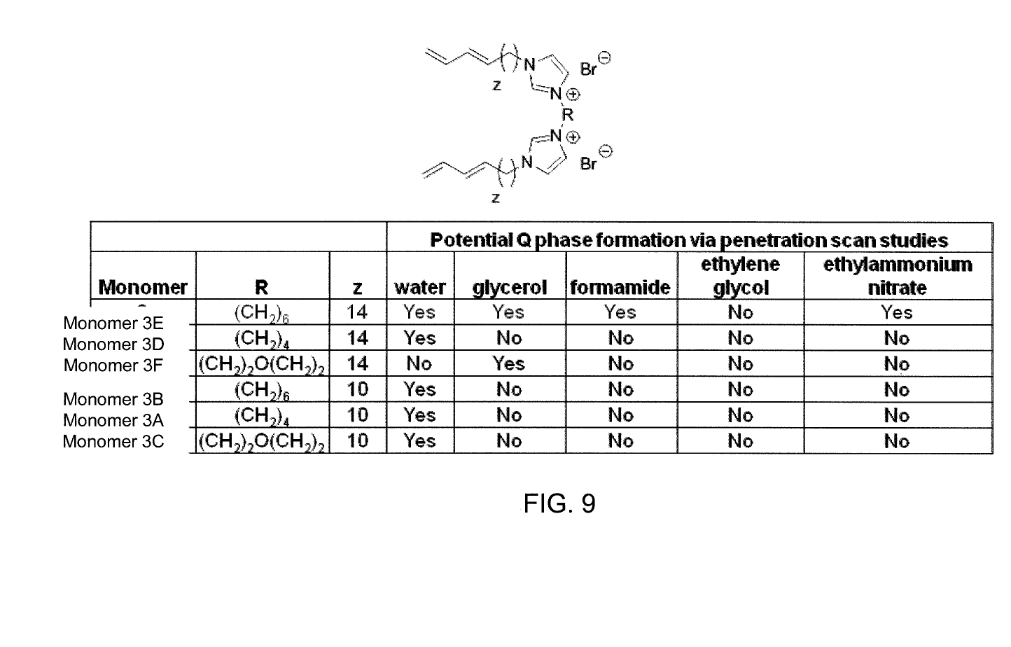

Cross-linking and subsequent XRD confirmation of retention of the QI phase in the methanol-cast 3e/glycerol films on glass slides has been performed. FIG. 6 below shows the X-Ray Diffraction (XRD) profile and polarized-light microscopy (PLM) optical texture of a less-than-10 μm-thick 3e/glycerol film cast from methanol solution and photo-cross-linked using the procedure shown in FIG. 5. The presence of a uniformly black PLM optical texture and a XRD profile characteristic of a Q phase confirm retention of the desired LLC phase in the final thin polymer film.

To our knowledge, this new formulation method with glycerol as the LLC phase-forming solvent provides the first successful example of thin-film solution-casting of a cross-linkable QI-phase mixture. We believe that optimization of this general procedure using glycerol or another polar, high boiling organic solvent, or slightly different gemini LLC monomer will lead to manufacturable supported thin film composite QI-phase LLC polymer membranes.

The use of glycerol and mixed water/glycerol solvent systems for QI-phase formation with monomer 3e was also found to alter the powder XRD diffraction unit cell dimensions of the formed QI phase, compared to the same monomer and phase formed with pure water. FIG. 7 illustrates powder XRD profiles of cross-linked QI-phase films of monomer 3e formed with approximately the same wt % total solvent ranging from pure water, 50/50 glycerol/water, and pure glycerol. The variation in the principal XRD diffraction peak for the QI phases suggests that the effective nanopore size of the resulting cross-linked QI-phase membranes may also change with the phase-forming solvent used, all else being the equal.

Pore size variations can be confirmed with water-based nanofiltration experiments with different size neutral molecular substrates to experimentally confirm an effective change in physical nanopore size by this QI-phase solvent substitution method, and to try other polar organic solvents for foaming the QI phases. The use of different hydrophilic solvents (or mixtures thereof) to form QI phases with cross-linkable LLC monomers represents a new approach to making nanoporous QI-phase polymer membranes with different nanopore sizes.

For this new formulation approach, the use of gemini imidazolium or pyrimidolium LLC monomers is believed essential. The gemini imidazolium LLC monomers have large, softer cations than gemini LLC monomers 1 and 2 that are better able to interact with the organic solvents and their mixtures. The analogous gemini phosphonium and ammonium LLC monomers are not able to form LLC phases with glycerol or related polar organic solvents.

### Use of Mixtures of Gemini LLC Monomers and Single-Head/Single-Tail Monomers to Vary Nanopore Size in Cross-linkable QI Phases

The XRD unit cell dimensions and effective nanopore size of cross-linkable QI phases may also be altered by mixing analogous single-head/single-tail (i.e., conventional surfactant configuration) LLC monomers with gemini LLC monomers such as 3e. The resulting gemini/monomeric LLC blends have been found to form cross-linkable QI-phases. For example, a mixture of 10 mol % single-head/single-tailed imidazolium derivative monomer 4 and 90 mol % gemini imidazolium LLC monomer 3e (FIG. 8) was found to readily form well-defined QI phases with water/glycerol mixtures. The presence of the single-head/single-tail LLC monomer additive may affect molecular packing and curvature in the LLC phase slightly, affording slightly different unit cell dimensions and possibly effective nanopore slit width. QI mixtures of monomer 3e and 4 are being processed and cross-linked into supported membranes in order to conduct water nanofiltration experiments with different size molecular substrates to confirm an effective nanopore size change in the cross-linked QI phases formed.

To our knowledge, the use of mixtures of double- and single-tailed LLC monomers to alter cross-linkable QI phase pore size in this fashion is new. Mixed surfactant systems have been used to make altered micelles and vesicles, but they are not typically used for LLC phase formation and feature size control in LLC Q-phases. In the work of O'Brien, careful blending of phospholipid-based monomers were a necessity for forming QII phases, not for tuning feature sizes in the phases.

### Details of Some Experiments

Materials and General Procedures. Chromium (IV) oxide, pyridine, allyltrimethylsilane, sec-butyl lithium (1.4 M in cyclohexane), aluminum oxide (activated, basic), 2-isopropoxy-4,4,5,5-tetramethyl-1,3,2-dioxaborolane, N,N,N′,N′-tetramethylethylene-1,2-diamine, hydrogen bromide, borane-tetrahydrofuran complex solution (1.0 M in THF), p-toluenesulfonyl chloride, diethylene glycol, 1,4-dibromobutane, 1,6-dibromohexane, imidazole, and 1-methylimidazole were obtained from Sigma-Aldrich Co., and used as purchased. Sulfuric acid was purchased from VWR and used as received. 11-Bromo-1-undecanol was obtained from Fluka and used as purchased. w-Pentadecalactone was obtained from SAFC and used as received. Sodium hydroxide was purchased from Fisher Scientific, and used as received. Filtration through silica gel was performed using 230-400 mesh, normal-phase silica gel purchased from Sorbent Technologies. The water used in LLC phase formulation and water filtration experiments was de-ionized, and had a resistivity of >12 mW cm⁻¹. Solupor E075-9H01A microporous support membrane (made from hydrophilically treated, ultrahigh-molecular-weight polyethylene (PE) fiber matte) was provided by DSM Solutech (Geleen, The Netherlands). Mylar sheets were purchased from American Micro Industry, Inc. All syntheses were performed using standard Schlenk line techniques unless otherwise noted.

Instrumentation. ¹H NMR spectra were obtained using a Bruker 300 Ultrashield™ (300 MHz) spectrometer, or Varian Inova 500 (500 MHz) and Inova 400 (400 MHz) spectrometers. Chemical shifts are reported in ppm relative to deuterated solvent. Fourier transform infrared spectroscopy (FT-IR) measurements were performed using a Matteson Satellite series spectrometer, as thin films on Ge crystals. Powder X-ray diffraction (XRD) spectra were obtained with an Inel CPS 120 diffraction system using a monochromated Cu Kₐ radiation source. The apparatus was equipped with a film holder to analyze membrane samples. All XRD spectra were calibrated against a silver behenate diffraction standard (d₁₀₀=58.4±0.1 Å). Powder XRD measurements were all performed at ambient temperature (21±1° C.). Polarized light microscopy (PLM) studies were performed using a Leica DMRXP polarizing light microscope equipped with a Q-Imaging MicroPublisher 3.3 RTV digital camera, Linkam LTS 350 thermal stage, and Linkam CI 94 temperature controller. Automatic temperature profiles and image capture was done using Linkam Linksys32 software. Photopolymerizations were conducted using a Spectroline XX-15A 365 nm UV lamp (1 mW cm ⁻² at the sample surface). UV light fluxes at the sample surface were measured using a Spectroline DCR-100X digital radiometer equipped with a DIX-365 UV-A sensor. Filtration studies were performed using custom designed, stainless steel, stirred, dead-end filtration cells for 2.5 cm diameter membrane samples. HRMS analysis was performed by the Central Analytical Facility in the Dept. of Chemistry and Biochemistry at the University of Colorado, Boulder. The ion conductivity of permeate solutions was measured using a VWR International electrical conductivity meter model 2052-B. Total organic carbon (TOC) analysis of permeate solutions containing organic solutes was conducted using a Test N Tube TOC kit (Hach), a COD reactor (DRM 200, Hach), and an Agilent 9453 UV-visible spectrophotometer. A Carver model C manual press equipped with a digitally temperature-controlled Carver 3796 heated platen set was used to manufacture membrane samples.

15-bromopentadecanoic acid. w-Pentadecalactone (20.69 g, 86.09 mmol, 100 mol %) was stirred in 48% HBr (98 mL, 1.076 mmol, 1250 mol %) in a 250-mL round-bottom flask equipped with a stir bar and reflux condenser. H₂SO₄ (13 mL, 243.88 mmol, 283 mol %) was added dropwise to minimize exothermic activity, liquefying the solid lactone. The yellow emulsion was heated to 115° C. and stirred for 40 h. The resultant brown solution was extracted into CHCl₃ (200 mL), washed with de-ionized H₂O (3×100 mL) and brine (3×100 mL), dried over anhydrous MgSO₄. The resulting organic solution was reduced under rotary vacuum to afford a light yellow solid, which was then recrystallized from hot CHCl₃ and washed with cold hexanes to afford the product as a white, crystalline solid (20.9 g, 76%). Spectroscopic characterization and purity data for this compound matched published data.

15-Bromopentadecanol. Borane-tetrahydrofuran complex solution (83 mL, 83 mmol, 210 mol %) was measured out into a 500-mL Schlenk flask equipped with a stir bar. 15-Bromo-1-pentadecanoic acid (12.70 g, 39.53 mmol, 100 mol %) was added slowly to minimize bubbling, and the light yellow solution turned clear over the course of 40 h of stirring. The reaction solution was then quenched with deionized (DI) H₂O (10 mL) dropwise, extracted into Et₂O (50 mL), and washed with de-ionized H₂O (3×50 mL) and brine (3×50 mL), dried over anhydrous MgSO₄, and evaporated to afford the product as a white solid (39.4 g, 99%). Spectroscopic characterization and purity data for this compound matched published data.

15-Bromopentadecanal. 15-Bromopentanol (6.69 g, 21.78 mmol, 100 mol %) was dissolved in CH₂Cl₂ (200 mL) in a 500-mL round-bottom flask equipped with a stir bar. To the clear, slightly yellow solution was added PCC on alumina (39.76 g, 37.48 mmol, 172 mol %) with vigorous stirring. The slurry was stirred at room temperature for 40 h. Reduction of the CH₂Cl₂ via rotary vacuum produced a dark brown solid that was stirred in diethyl ether and filtered through a pad of SiO₂, washing with diethyl ether (700 mL). Concentration of the diethyl ether under rotary evaporation afforded the product as a white solid (21.1 g, 92%). Spectroscopic characterization and purity data for this compound matched published data.

14-Bromotetradeca-1,3-diene. Synthesized as described by Pindzola, B. A.; Hoag, B. P.; Gin, D. L. J. Am. Chem. Soc. 2001, 123, 4617 (Pindzola, et al.). Spectroscopic characterization and purity data for this compound matched published data.

18-Bromooctadeca-1,3-diene. Synthesized as described in Pindzola, et al. Spectroscopic characterization and purity data for this compound matched published data.

1,1′-(1,4-Butanediyl)bisimidazole. Synthesized as described in Bara, J. E., Hatakeyama, E. S.; Zeng, X.; Noble, R. D.; Gin, D. L. Liq. Cryst. 2010, 37, 1587 (Bara, et al.) Spectroscopic characterization and purity data for this compound matched published data.

1,1′-(1,6-Hexanediyl)bisimidazole. Synthesized as described in Bara, et al. Spectroscopic characterization and purity data for this compound matched published data.

1,1′-(Oxydi-2,1-ethanediyl)bisimidazole. Synthesized as described in Bara, et al. Spectroscopic characterization and purity data for this compound matched published data.

1,4-Bis(tetradeca-11,13-dienylimidazolium)butane dibromide (3a). 14-Bromo-tetradeac-1,3-diene (0.912 g, 3.36 mmol, 213 mol %) and 1,1′-(1,4-butanediyl)bisimidazole (0.30 g, 1.58 mmol, 100 mol %) were dissolved in acetonitrile (25 mL) and toluene (10 mL) in a 100-mL round-bottom flask equipped with a stir bar and reflux condenser. The clear, light yellow solution was stirred at 86° C. for 70 h. Cooling to room temperature and concentration of the solvent under rotary evaporation afforded a light brown solid which was stirred in diethyl ether (4×50 mL) and filtered to afford the product as a white, crystalline solid (0.7 g, 57%). ¹H NMR (300 MHz, CDCl₃): d 10.39 (s, 2H), 8.09 (s, 2H), 7.19 (s, 2H), 6.31 (dt, J=10.2, 17.0, 2H), 6.04 (dd, J=10.4, 15.2, 2H), 5.70 (m, 2H), 5.08 (dd, J=1.2, 16.9, 2H), 4.95 (d, J=10.1, 2H), 4.61 (t, 4H), 4.25 (m, 4H), 2.23 (t, 4H), 2.07 (q, J=6.9, 4H), 1.98-1.75 (m, 4H), 1.30 (d, J=20.8, 28H). ¹³C NMR (300 MHz, CDCl₃): δ 26.43, 26.63, 29.08, 29.29, 29.46, 29.53, 30.33, 32.67, 48.98, 50.38, 114.73, 121.31, 123.85, 130.98, 135.70, 136.85, 137.48. IR (thin film, MeOH): 3070, 3012, 2924, 2851, 1652, 1564, 1464, 1165, 1004, 897 cm⁻¹. HRMS (ES) calcd. for C₃₈H₆₄BrN₄ (M⁺M⁺Br⁻): 655.4321; observed: 655.4310.

1,6-Bis(tetradeca-11,13-dienylimidazolium)hexane dibromide (3b). 1,1-(1,6-Hexanediyl)bisimidazole (1.07 g, 4.89 mmol, 100 mol %) was dissolved in acetonitrile (15 mL) in a 100-mL round-bottom flask equipped with a stir bar and reflux condenser. Addition of 14-bromotetradeda-1,3-diene (2.70 g, 9.90 mmol, 203 mol %) produced a clear, light yellow solution that was stirred at 86° C. for 96 h. Upon cooling to room temperature, solvent was concentrated under rotary vacuum to afford an off-white, waxy solid that was stirred in hexanes (3×50 mL) and filtered to afford the product as a white, crystalline solid (3.1 g, 82%). ¹H NMR (300 MHz, DMSO-d₆): δ 9.25 (s, 2H), 7.81 (ds, J=1.4, 4H), 6.29 (dt, J=10.2, 16.9, 2H), 6.03 (dd, J=10.4, 15.2, 2H), 5.71 (m, 2H), 5.09 (dd, J=1.7, 17.0, 2H), 4.95 (dd, 2H), 4.16 (t, J=7.1, 8H), 2.04 (q, J=6.7, 4H), 1.78 (m, 8H), 1.24 (m, 32H). ¹³C NMR (300 MHz, DMSO-d₆): δ 25.29, 25.96, 28.80, 29.05, 29.08, 29.28, 29.34, 29.53, 29.79, 32.35, 49.12, 49.30, 115.56, 122.90, 131.34, 135.72, 136.43, 137.67. IR (thin film, MeOH): 3081, 3008, 2928, 2858, 1647, 1567, 1463, 1164, 1003, 953, 896 cm⁻¹. HRMS (ES) calcd. for C₄₀H₆₈BrN₄ (M⁺M⁺Br⁻): 683.4622; observed: 683.4642.

1,1′-(oxydi-2,1-ethanediyl)bis[3-(tetraadeca-11,13-dienyl)imidazolium] dibromide (3c). Synthesized as described in U.S. patent application Ser. No. 12/121,617 filed May 15, 2008, and published as patent publication 20090173693. Spectroscopic characterization and purity data for this compound matched published data.

1,4-Bis(octadeca-15,17-dienylimidazolium)butane dibromide (3d). 1,1′-(1,4-Butanediyl)bisimidazole (0.40 g, 2.10 mmol, 100 mol %) and 18-bromooctadeca-1,3-diene (1.47 g, 4.45 mmol, 212 mol %) were dissolved in acetonitrile (20 mL) and toluene (5 mL) in a 100 mL round bottom flask equipped with a stir bar and reflux condenser. The clear, light yellow solution was stirred at 86° C. for 196 h. Upon cooling to room temperature, the mixture was concentrated via rotary vacuum to afford a crude, off-white solid, which was stirred in hexanes (4×100 mL) and filtered to afford the product as a white, crystalline sold (1.5 g, 82%). ¹H NMR (300 MHz, DMSO-d₆): d 9.25 (s, 2H), 7.81 (m, 4H), 6.28 (m, 2H), 6.03 (ddd, J=0.6, 10.7, 11.7, 2H), 5.72 (dd, J=7.3, 14.8, 2H), 5.08 (m, 2H), 4.95 (dd, J=1.9, 10.1, 2H), 4.17 (m, 8H), 2.04 (q, J=7.0, 4H), 1.77 (m, 8H), 1.25 (m, 44H). ¹³C NMR (300 MHz, DMSO-d₆): δ 25.54, 26.06, 28.39, 28.58, 28.61, 28.85, 28.97, 28.99, 29.04, 29.33, 31.88, 48.06, 48.88, 115.09, 122.41, 122.54, 130.87, 135.27, 136.01, 137.22. IR (thin film, MeOH): 30.70, 3005, 2920, 2851, 1656, 1568, 1468, 1338, 1165, 1004, cm⁻¹. HRMS (ES) calcd. for C₄₆H₈₀BrN₄ (M⁺M⁺Br⁻): 767.5536; observed: 767.5561.

1,6-bis(octadeca-15,17-dienylimidazolium)hexane dibromide (3e). 18-Bromooctadeca-1,3-diene (4.25 g, 12.90 mmol, 204 mol %) and 1,1′-(1,6-hexanediyl)bisimidazole (1.38 g, 6.32 mmol, 100 mol %) were dissolved in acetonitrile (70 mL) in a 250-mL round-bottom flask equipped with a stir bar and reflux condenser. The clear, light yellow solution was stirred at 84° C. for 100 h. Concentration of the reaction solvent via rotary evaporation produced an off-white solid, which was stirred in hexanes (3×200 mL) and filtered to afford the product as a white, crystalline solid (5.2 g, 93%). ¹H NMR (300 MHz, CDCl₃): δ 10.46 (s, 2H), 7.98 (s, 2H), 7.25 (s, 2H), 6.30 (dt, J=10.1, 16.8, 2H), 6.03 (dd, J=10.4, 15.1, 2H), 5.71 (dd, J=7.3, 14.8, 2H), 5.07 (d, J=16.7, 2H), 4.94 (d, J=10.1, 2H), 4.46 (t, J=7.3, 4H), 4.28 (t, J=7.4, 4H), 2.00 (m, 12H), 1.32 (m, 58H). ¹³C NMR (300 MHz, DMSO-d₆): δ 24.78, 25.50, 28.35, 28.58, 28.60, 28.84, 28.94, 28.99, 29.03, 29.31, 31.87, 48.62, 48.81, 115.03, 122.42, 130.84, 135.23, 135.95, 137.19. IR (thin film, MeOH): 3073, 3004, 2920, 2851, 1651, 1563, 1467, 1168, 1003, 949, 919 cm⁻¹. HRMS (ES) calcd. for C₄₈H₈₄BrN₄ (M⁺M⁺Br⁻): 795.5897; observed: 795.5874.

1,1′-(Oxydi-2,1-ethanediyl)bis[3-(octadeca-15,17-dienyl)imidazolium] dibromide (3f). 18-Bromooctadeca-1,3-diene (1.05 g, 3.18 mmol, 214 mol %) and 1,1-(oxydi-2,1-ethanediyl)bisimidazole (0.31 g, 1.49 mmol, 100 mol %) were dissolved in acetonitrile (20 mL) and toluene (10 mL) in a 50-mL round-bottom flask equipped with a stir bar and reflux condenser. The clear, light yellow solution was stirred at 86° C. for 100 h. Upon cooling to room temperature the reaction was concentrated under rotary vacuum to produce an off-white solid, which was stirred in hexanes (3×100 mL) and filtered to afford the product as a white, crystalline solid (1.0 g, 78%). ¹H NMR (300 MHz, DMSO-d₆): δ 9.24 (s, 2H), 7.79 (m, 2H), 7.71 (m, 2H), 6.29 (dt, J=10.2, 16.8, 2H), 6.03 (dd, J=10.5, 15.3, 2H), 5.72 (dd, J=7.4, 14.7, 2H), 5.08 (d, J=16.9, 2H), 4.95 (d, J=10.1, 2H), 4.36 (d, J=4.1, 4H), 4.18 (d, J=7.6, 4H), 3.78 (s, 4H), 2.03 (t, J=7.0, 4H), 1.77 (m, 4H), 1.23 (m, 44H). ¹³C NMR (300 MHz, DMSO-d₆): δ 25.56, 28.43, 28.59, 28.61, 28.86, 28.89, 29.01, 29.05, 29.45, 31.89, 48.66, 48.81, 68.01, 115.08, 122.11, 122.80, 130.87, 135.26, 136.27, 137.21. IR (thin film, MeOH): 3078, 3010, 2922, 2850, 1658, 1565, 1468, 1163, 1124, 1003, 950 cm⁻¹. HRMS (ES) calcd. for C₄₆H₈₀BrN₄ (M⁺M⁺Br⁻): 783.5535; observed: 783.5510.

3-Methyl-1-(octadeca-15,17-dienyl)imidazolium dibromide (4). 1-Methylimdazole (0.24 g, 2.90 mmol, 100 mol %) and 18-bromooctadeca-1,3-diene (1.07 g, 3.30 mmol, 111 mol %) were dissolved in toluene (5 mL) and acetonitrile (5 mL) in a 50-mL round-bottom flask equipped with a stir bar and reflux condenser. The solution was stirred at 81° C. for 24 h. The reaction was cooled to room temperature and then precipitated into diethyl ether. The solid that precipitated out was filtered and washed with hexanes to afford the product as a white crystalline powder (1.1 g, 93%). ¹H NMR (300 MHz, DMSO-d₆): d 9.11 (s, 1H), 7.77 (t, 1H), 7.70 (t, 1H), 6.30 (dt, J=10.2, 16.5, 1H), 6.03 (m, 1H), 5.72 (m, 1H), 5.09 (dd, 1H), 4.94 (dd, 1H), 4.14 (t, J=7.2, 2H), 3.84 (s, 3H), 2.04 (q, J=7.1, 2H), 1.77 (m, 2H), 1.42-1.10 (m, 22H). ¹³C NMR (300 MHz, CDCl₃): δ 26.40, 29.12, 29.32, 29.35, 29.50, 29.63, 29.71, 29.72, 29.75, 29.77, 30.44, 32.69, 36.92, 50.39, 114.68, 121.65, 123.30, 130.93, 135.81, 137.50, 138.24. IR (thin film, MeOH): 3062, 2920, 2852, 1640, 1568, 1472, 1177, 1012, 951, 920 cm⁻¹. HRMS (ES) calcd. for C₄₄H₈₈BrN₄ (M⁺M⁺Br⁻): 741.5394; observed: 741.5404.

Preparation of LLC Phases, Determination of LLC Phase Behavior, and Elucidation of LLC Phase Diagrams. Previously published methods (Hatakeyama, E. S.; Wiesenauer, B. R.; Gabriel, C. J.; Noble, R. D.; Gin, D. L. Chem. Mater. 2010, 22, 4525) (Hatakeyama, 2010) were used to examine the LLC phase behavior. LLC samples of specific composition were made by adding an appropriate amount of monomer(s) and solvent to custom made glass vials. A photo-initiator, 2-hydroxy-2-methylpropiophenone (HMP) was added if required, and the vials were sealed with Parafilm. LLC samples were mixed by alternately hand-mixing and centrifuging (2800 rpm) until completely homogenous. It should be noted that the LLC samples are sensitive to water loss or gain, depending on the solvent system. Special attention was taken to keep the samples sealed as much as possible during sample mixing and transferring to minimize composition drift.

For samples with low viscosity solvent systems (e.g., water), LLC samples of specific composition were prepared by adding the desired amount of monomer to custom-made glass vials, followed by the addition of an appropriate amount of solvent by weight via pipette. Photo-initiator was then added if required. The vials were sealed with Parafilm and centrifuged at 2800 rpm. Samples were then alternately hand-mixed and centrifuged until homogeneous.

For samples with high viscosity solvent systems (e.g., glycerol), LLC samples of specific composition were prepared by adding the desired amount of solvent to custom-made glass vials, followed by the addition of monomer by weight via spatula. Photo-initiator was then added if required. The vials were sealed with Parafilm and centrifuged at 2800 rpm. Samples were then alternately hand-mixed and centrifuged until homogeneous.

For LLC phases of mixed monomers, samples were prepared by lightly grinding the desired ratio of the two monomers with a mortar and pestle. Extra care was taken to ensure the samples were thoroughly mixed and no monomer was spilled during this process. LLC samples of specific composition were then made as previously described above using the mixed monomer powder.

The range of each LLC phase was determined using variable-temperature PLM. Specimens were prepared by pressing samples between a microscope slide and microscope cover-slip. The assembly was then placed on the PLM thermal stage and annealed past its isotropic temperature or up to 85° C. (whichever came first). The sample was slowly cooled and allowed to come back to its room temperature phase. The sample was then heated to 95° C. at a rate of 5° C./min with digital image capture every 1.25° C. and continuous recording of the light intensity. Images were captured at 125× magnification. Changes in optical texture and light intensity were used to determine changes in the LLC phase of the mixture.

The identity of each observed phase was then confirmed by XRD by analyzing a point in each distinct phase region as elucidated by PLM. XRD spectra of the samples were taken either by using a film holder apparatus for room temperature spectra or a heated stage for higher temperature spectra. In the film holder, a sample was placed between Mylar sheets with an appropriate spacer, annealed, placed in the film holder, and then examined. On the heated stage, a sample was placed in an aluminum XRD pan and a piece of Mylar was used to cover the sample to prevent evaporation. The spacing of the XRD peaks is used to determine the LLC phase. Using the combined PLM and XRD data, phase diagrams were plotted for each LLC monomer as a function of composition and temperature.

Fabrication of Supported Q_{I}-phase Polymer Membranes by the Old “Melt-Press-Photopolymerize” Method. (Hatakeyama, 2010) Supported membranes of the cross-linked Q_{I}-phase of the monomers were made using a modified hot-pressing method previously published. In this process, a Q_{I}-phase monomer gel mixture containing the appropriate amounts of the LLC monomer(s), solvent, and HMP was prepared. A small amount of the LLC monomer mixture (50-100 mg) was then placed on a piece of Solupor E075-9H01A support membrane. This was then placed between two Mylar sheets to prevent water evaporation. The membrane sample between Mylar sheets was then placed between two mirror-like, polished aluminum plates. The aluminum plates provide a smooth, heat conductive surface for hot-pressing of the membrane assembly. The membrane assembly was then pressed using a Carver manual press equipped with temperature controlled heated platens pre-heated to 60° C. An applied force of 1-8 tons for 10 min was used to infuse the Q_{I}-phase monomer mixture completely through the entire depth of the Solupor E075-9H01A support. The membrane sample removed from the press and aluminum plates. It was then clamped between two pre-heated quartz plates and placed on a temperature controlled hot-stage set to the required temperature. Samples were then photo-polymerized with a 365 nm UV light source (ca. 1 mW cm⁻²) for 1 h to radically photo-cross-link the Q_{I}-phase nanostructure. Cross-linking and stabilization of the Q_{I}-phase nanostructure in the Solupor E075-9H01A support membrane was verified by powder XRD analysis.

Water Nanofiltration Testing of Supported Q_{I}-Phase Polymer Membranes. (Hatakeyama, 2010) Membrane discs of the supported Q_{I}-phase membranes (2.5 cm in diameter) were cut from sheets using a sharpened circular punch die. For membrane samples prepared from mixed or non-aqueous solvents, the discs were soaked in stirred de-ionized water (ca. 200 mL) for 48 h prior to use. The membrane discs were then installed into custom-made, stainless steel, stirred dead-end filtration cells. The membrane holder has a 2.5 cm outer diameter and an effective filtration area of 3.8 cm². De-ionized water was filtered through the membrane using 2.76×10⁶ Pa (400 psi) of N₂ pressure as the driving force. The de-ionized water was filtered at ambient temperature (21±1° C.) until at least 5 mL of permeate was collected. The first filtration with de-ionized water is to ensure the integrity of the membrane and also to clean out any unpolymerized monomer or other contaminates that might remain in the membrane after processing. For membrane samples processed with mixed or non-aqueous solvents, another 2-4 mL of permeate was collected and analyzed to ensure all the processing solvent was removed.

All filtration experiments were then carried out using aqueous feed solutions containing a single solute at 2000 ppm concentration. Each stirred dead-end filtration cell was loaded with 25 mL of the feed solution and pressurized to 2.76×10⁶ Pa (400 psi) of N₂ pressure. The first 1-2 mL of permeate were discarded. The next 2-4 mL of permeate were then collected and examined to determine thickness-normalized permeance and rejection.

For all filtration studies, the thickness-normalized permeance (J) was calculated as follows using Eq. 1:

$$J = \frac{Δ V}{A Δ t} \frac{1}{Δ P} Δ x , \qquad ( Eq . 1 )$$

where A is the surface area of the membrane (3.8 cm²), DV is the permeate volume, and Dt is the time needed to collect the permeate, DP is the transmembrane pressure, and Dx is the membrane thickness. The rejection (R) was calculated as follows using Eq. 2:

$$R = ( 1 - \frac{{C}_{permeate}}{{C}_{feed}} ) \times 100 \% , \qquad ( Eq . 2 )$$

where Cₚₑᵣₘₑₐₜₑ and C_{feed} are the concentration of solute in the permeate and feed, respectively. All reported permeances and rejections are averages of three different membrane samples in separated experiments. Reported errors are standard deviations calculated using three different membranes in separate experiments.

Permeate Analysis. (Hatakeyama, 2010) The concentrations of NaCl, KC, MgCl₂, and CaCl₂ in the permeate solution were determined using an electrical conductivity meter. The conductivity meter was calibrated for each salt using standard aqueous solutions of each salt. The concentrations of all the neutral organic solutions were determined using TOC digestion kit with a modified procedure based on Hach method 10173 and subsequent UV-visible analysis. Calibration plots made with standard solutions prior to each study to ensure accuracy.

Estimation of the Effective Pore Size Using the Ferry Equation. The Ferry equation (Eq. 3) describes rejection as a function of effective solute size and effect pore size. This simple steric pore model assumes that the solutes are spherical and the membrane pores are uniform cylinders. The Ferry equation has been used to describe a variety of porous membranes. The Ferry equation is shown as follows in Eq. 3:

R=[1−(1−rₛₒₗᵤₜₑ/rₚₒᵣₑ)²]²×100%, (Eq. 3)

where R is the rejection in percent, rₛₒₗᵤₜₑ is the solute diameter, and rₚₒᵣₑ is the pore diameter. The observed rejection data of the Q_{I}-membranes for the non-charged solutes (i.e., sucrose, glucose, glycerol, and ethylene glycol) were fitted to the Ferry equation to estimate the effective pore size in the absence of charge-charge effects.

Procedure for Solution-Casting and Photo-Cross-Linking of a Q_{I}-Phase Thin Film of 3e/glycerol from Methanol. A casting solution was prepared by adding an appropriate amount of LLC monomer, glycerol, and HMP to a 10-mL glass vial and dissolving the components in the desired amount of methanol. A small amount of the casting solution was then pipetted onto a glass slide and allowed to air-dry for 10 min at room temperature. The glass slide was then warmed on a temperature controlled hot stage 10° C. every 2 min up to 75° C. The sample was then cooled to room temperature and placed in a specially designed photo-polymerization chamber with an aluminum base and a Pyrex glass plate cover. The atmospheric O₂ in the chamber was removed by alternating vacuum (2000 mtorr) and argon purge cycles three times. The argon-filled polymerization chamber was then warmed to 65° C. via a temperature-controlled hot stage, and the chamber was then irradiated with a 365 nm UV lamp (1 mW cm⁻²) for 1 h with the sample maintained at 65° C. Cross-linking and stabilization of the methanol solution-cast Q_{I}-phase was verified by powder XRD and PLM analyses.

### Results

In an embodiment, a photopolymerized (using HMP) membrane of monomer 3E approximately three microns thickness having approximately 0.96 nanometer nanopores was formed on porous poly(ether sulfone) (PES) substrate membranes, the PES membranes in turn supported on a Holytex 3329 cloth support.

Fourier transform infrared spectroscopy of an absorption band in the monomer samples originating from the C—H out-of-plane wagging of the 1,3-diene units located on the end of the tails of the monomer suggests more than 90% conversion of the 1,3-diene units of the QI-phase LLC sample. PXRD analysis of the polymerized membrane samples show that the QI-phase nanostructure is retained.

### Expectations

Based upon our work, we expect that imidazolium or pyridinium gemini LLC monomers having interconnecting alkyl or oligo(ethylene oxide) groups of length 4 to 30 or 40 and double-diene-terminated aliphatic tails with X (FIG. 3) between ten and 30 should form membranes when processed according to a variation of the herein-described process. We also expect also expect that some gemini LLC monomers having double-diene-terminated aliphatic tails with X between ten and 30 and having interconnecting ether groups of the form —(CH₂)₂—O—(CH₂)₂— of length less than 30 or 40 may also form membranes when processed according to a variation of the herein-described high-volatility solvent-casting with low-volatility polar solvent process. The upper limits on tail and connecting chain length are likely imposed by the high melting point associated with long chain molecules.

It is expected that the herein described membranes may be formed as an active layer for thin film composite nanofiltration on a variety of porous substrate membranes, including many membranes not described in detail herein.

Based upon our work, we expect that single-tail monomers used to form QI-phases in mixtures with gemini monomers, as described in the section entitled “Use of Mixtures of gemini LLC Monomers and Single-Head/Single-Tail Monomers to Vary Nanopore Size in Cross-linkable QI Phases” above, may have diene-terminated aliphatic tails having a total length of from fourteen to thirty carbon atoms. It is expected that QI-phases should form, and crosslinked membranes formed with the process described herein, with mixtures having concentrations of the single-tail from zero to <tbd> mol %, with the balance being Gemini monomers.

It is also expected that salts of the imidazolium cations other than bromide salts herein described may also form QI-phases and membranes as herein described, including bromide, fluoride, iodide and choride salts (hereinafter halides) as well as nitrate, acetate, and sulfate salts.

Solvent casting is a general term for preparing films of a substance by dissolving the substance in at least one volatile casting solvent to make a solution (or “dope”) having lower viscosity than the substance. The solution is then applied to and/or spread on a substrate, or poured into a mold, whereupon the volatile casting solvent(s) is removed—usually by evaporation—thereby increasing viscosity of the substance. Applying and spreading of the solution on the substrate has been done in many ways in past solvent-casting operations of other materials, including dipping, spraying, spinning, extruding, pouring, brushing, and smearing or spreading with a blade. Once the volatile casting solvent is removed, the resulting film may be subjected to additional processing, may be removed from the substrate as in the 1896 Celluloid film-making process (where the substance was nitrocellulose, and substrate a polished wheel), or allowed to remain on the substrate, as with plastic-coated tool handles or some coated fabrics.

In this application, the casting solvent is the high volatility casting solvent, and the substance is the mixture of low-volatility polar organic solvent and the monomers discussed above.

### Combinations

It is expected that various alternatives and combinations of elements may function. Some possible combinations of elements include:

A method designated A of forming a nanoporous membrane including steps of preparing a solution of a gemini imidazolium lyotropic liquid crystal monomer, a polar low-volatility organic solvent, and a radical photo-initiator in a volatile organic solvent; solvent-casting the solution onto a porous material; evaporating the volatile organic solvent; heating to a temperature such that the gemini imidazolium monomer forms a Q-phase material; photopolymerizing the imidazolium monomer by exposing the radical photo-initiator to light; and exchanging the polar low-volatility organic solvent to water.

A method designated AB including the method designated A wherein the Gemini imidazolium lyotropic liquid crystal monomer is selected from the group consisting of 1,4-Bis(tetradeca-11,13-dienylimidazolium)butane dihalide (monomer 3a), 1,6-Bis(tetradeca-11,13-dienylimidazolium)hexane dihalide (monomer 3b), 1,1′-(oxydi-2,1-ethanediyl)bis[3-(tetraadeca-11,13-dienyl)imidazolium] dihalide (monomer 3c), 1,4-Bis(octadeca-15,17-dienylimidazolium)butane dihalide (monomer 3d), 1,6-bis(octadeca-15,17-dienylimidazolium)hexane dihalide (monomer 3e), and 1,1′-(Oxydi-2,1-ethanediyl)bis[3-(octadeca-15,17-dienypimidazolium] dihalide (monomer 3f).

A method designated AC including the method designated AB wherein the gemini imidazolium lyotropic liquid crystal monomer is monomer 3e.

A method designated AD including the method designated A, AB, or AC wherein the solution further comprises a single-head/single-tail LLC monomer having a double-diene terminated tail of length fourteen to twenty.

A method designated AE including the method designated AD wherein the single-head/single-tail monomer is 3-Methyl-1-(octadeca-15,17-dienyl)imidazolium dihalide (monomer 4).

A method designated AF including the method designated AD or AE wherein the gemini imidazolium lyotropic liquid crystal monomer is monomer 3e.

A method designated AG including the method designated AF, AE, or AD wherein the single-head/single-tail monomer is present in concentrations of from zero to ten mol %.

A method designated AH including the method designated A, AB, AC, AD, AE, AF, or AG, wherein the gemini imidazolium lyotropic liquid crystal monomer has a linking alkyl group of length from four to thirty.

A method designated AK including the method designated A, AD, AE, or AF, wherein the gemini imidazolium lyotropic liquid crystal monomer has a double-diene-terminated aliphatic chain of total length between fourteen and thirty.

A nanoporous membrane designated B comprising a polymer formed from at least one gemini imidazolium lyotropic liquid crystal monomer selected from the group consisting of 1,4-Bis(tetradeca-11,13-dienylimidazolium)butane dihalide (monomer 3a), 1,6-Bis(tetradeca-11,13-dienylimidazolium)hexane dihalide (monomer 3b), 1,1′-(oxydi-2,1-ethanediyl)bis[3-(tetraadeca-11,13-dienyl)imidazolium] dihalide (monomer 3c), 1,4-Bis(octadeca-15,17-dienylimidazolium)butane dihalide (monomer 3d), 1,6-bis(octadeca-15,17-dienylimidazolium)hexane dihalide (monomer 3e), and 1,1′-(Oxydi-2,1-ethanediyl)bis[3-(octadeca-15,17-dienyl)imidazolium] dihalide (monomer 3f); the membrane having QI-phase structure.

A membrane designated BA including the membrane designated B wherein the gemini imidazolium lyotropic liquid crystal monomer is monomer 3e.

A membrane designated BA1 including the membrane designated B wherein the Gemini imidazolium lyotropic liquid crystal monomer is a dibromide.

A membrane designated BB including the membrane designated B or BA wherein the polymer is further formed from at least one single-head/single-tail LLC monomer.

A membrane designated BC including the membrane designated BB wherein the single-head/single-tail monomer is 3-Methyl-1-(octadeca-15,17-dienyl)imidazolium halide (monomer 4).

A membrane designated BC1 including the membrane designated BC wherein the single-head/single-tail monomer halide is bromide.

A thin-film composite membrane designated BD comprising the nanoporous membrane designated B, BA, BB, or BC disposed upon a porous supporting membrane.

A nanoporous membrane designated C comprising a polymer formed from at least one gemini lyotropic liquid crystal (LLC) monomer salt, each arm of the gemini LLC comprising a polar group selected from imidazolium and pyridinium, a double-diene tail of total length 14 to 30, and a anion comprising a halide, nitrate, acetate, or sulfate, the gemini LLC having a linking group of length from 4 to 30, the membrane having QI-phase structure. A method designated D comprising the method designated A, AA-AK, or the membrane B, BA-BD, or C, formed using glycerol as a polar low-volatility organic solvent.

A method designated E comprising the method designated A, AA-AK, or D, or the membrane B, BA-BD, or C, formed using methanol, ethanol, or isopropanol as the high-volatility casting solvent.

A method designated F comprising the method designated A, AA-AK, or the membrane B, BA-BD, or C, formed using ethylene glycol, glycerol, formamide, N-methylformamide, dimethylformamide, or N-methylsydnone as a polar low-volatility organic solvent.

While the invention has been particularly shown and described with reference to a preferred embodiment thereof, it will be understood by those skilled in the art that various other changes in the form and details may be made without departing from the spirit and scope of the invention. It is to be understood that various changes may be made in adapting the invention to different embodiments without departing from the broader inventive concepts disclosed herein and comprehended by the claims that follow.

What is claimed is:

1. A method of forming a nanoporous membrane comprising:
preparing a solution of a gemini imidazolium lyotropic liquid crystal monomer, a polar low-volatility organic solvent, and a radical photo-initiator in a volatile organic solvent;
solvent-casting the solution onto a porous material;
evaporating the volatile organic solvent;
heating to a temperature such that the gemini imidazolium monomer forms a Q-phase material;
photopolymerizing the imidazolium monomer by exposing the radical photo-initiator to light; and
removing the polar low-volatility organic solvent.

2. The method of claim 1 wherein the gemini imidazolium lyotropic liquid crystal monomer is selected from the group consisting of 1,4-Bis(tetradeca-11,13-dienylimidazolium)butane dihalide (monomer 3a), 1,6-Bis(tetradeca-11,13-dienylimidazolium)hexane dihalide (monomer 3b), 1,1′-(oxydi-2,1-ethanediyl)bis[3-(tetraadeca-11,13-dienyl)imidazolium] dihalide (monomer 3c), 1,4-Bis(octadeca-15,17-dienylimidazolium)butane dihalide (monomer 3d), 1,6-bis(octadeca-15,17-dienylimidazolium)hexane dihalide (monomer 3e), and 1,1′-(Oxydi-2,1-ethanediyl)bis[3-(octadeca-15,17-dienyl)imidazolium] dihalide (monomer 3f).

3. The method of claim 2 wherein the gemini imidazolium lyotropic liquid crystal monomer is monomer 3e.

4. The method of claim 3 wherein halide of the gemini imidazolium lyotropic liquid crystal monomer is bromide.

5. The method of claim 1 wherein the solution further comprises a single-head/single-tail LLC monomer.

6. The method of claim 5 wherein the Gemini imidazolium lyotropic liquid crystal monomer is selected from the group consisting of 1,4-bis(tetradeca-11,13-dienylimidazolium)butane dihalide (monomer 3a), 1,6-bis(tetradeca-11,13-dienylimidazolium)hexane dihalide (monomer 3b), 1,1′-(oxydi-2,1-ethanediyl)bis[3-(tetraadeca-11,13-dienyl)imidazolium] dihalide (monomer 3c), 1,4-bis(octadeca-15,17-dienylimidazolium)butane dihalide (monomer 3d), 1,6-bis(octadeca-15,17-dienylimidazolium)hexane dihalide (monomer 3e), and 1,1′-(Oxydi-2,1-ethanediyl)bis[3-(octadeca-15,17-dienyl)imidazolium] dihalide (monomer 3f).

7. The method of claim 6 wherein the single-head/single-tail monomer is 3-methyl-1-(octadeca-15,17-dienyl)imidazolium dibromide (monomer 4).

8. The method of claim 7 wherein the gemini imidazolium lyotropic liquid crystal monomer is monomer 3e.

9. The method of claim 1 wherein the gemini imidazolium lyotropic liquid crystal monomer has a linking alkyl group of length from four to thirty.

10. The method of claim 1 wherein the gemini imidazolium lyotropic liquid crystal monomer has a double-diene-terminated aliphatic chain of total length between fourteen and thirty.

11. The method of claim 10 wherein the gemini imidazolium lyotropic liquid crystal monomer has a linking alkyl group of length from four to thirty.

12. The method of claim 11 wherein the Gemini imidazolium lyotropic liquid crystal monomer is monomer 3e.

13. A nanoporous membrane comprising a polymer of at least one gemini imidazolium lyotropic liquid crystal monomer selected from the group consisting of a salt of 1,4-Bis(tetradeca-11,13-dienylimidazole)butane (monomer 3a), 1,6-Bis(tetradeca-11,13-dienylimidazole)hexane (monomer 3b), 1,1′-(oxydi-2,1-ethanediyl)bis[3-(tetraadeca-11,13-dienyl)imidazole] (monomer 3c), 1,4-Bis(octadeca-15,17-dienylimidazole)butane (monomer 3d), 1,6-bis(octadeca-15,17-dienylimidazole)hexane (monomer 3e), and 1,1′-(Oxydi-2,1-ethanediyl)bis[3-(octadeca-15,17-ienyl)imidazole] (monomer 3f); the membrane being nanoporous with QI-phase structure.

14. The membrane of claim 13 wherein the gemini imidazole lyotropic liquid crystal monomer is monomer 3e.

15. The membrane of claim 14 wherein the polymer further incorporates a single-head/single-tail LLC monomer.

16. The membrane of claim 13 wherein the polymer further incorporates a single-head/single-tail LLC monomer.

17. The membrane of claim 16 wherein the single-head/single-tail monomer is 3-Methyl-1-(octadeca-15,17-dienyl)imidazolium dibromide (monomer 4).

18. The membrane of claim 13 wherein the gemini imidazolium lyotropic liquid crystal monomer is monomer 3e.

19. A thin-film composite membrane comprising the nanoporous membrane of claim 13 disposed upon a porous supporting membrane.

20. The membrane of claim 19 wherein the gemini imidazolium lyotropic liquid crystal monomer is monomer 3e.

21. The membrane of claim 20 wherein the polymer further incorporates a single-head/single-tail LLC monomer.

22. The membrane of claim 21 wherein the single-head/single-tail monomer is 3-Methyl-1-(octadeca-15,17-dienyl)imidazolium dibromide (monomer 4).

23. The membrane of claim 13 wherein the salt is a imidazolium salt comprising a halide selected from the group consisting of fluoride, bromide, chloride, and iodide.

24. A nanoporous membrane designated C comprising a polymer formed from at least one gemini lyotropic liquid crystal (LLC) monomer salt, each twin of the gemini LLC comprising a pyridinium group, a double-diene tail of total length 14 to 30, and a anion comprising a halide, nitrate, acetate, or sulfate, the gemini LLC having a linking group of length from 4 to 30, the membrane having QI phase structure.
